(19) United States
(12) Patent Application Publication
(10) Pub. No.: US 2023/0267585 A1
(43) Pub. Date: Aug. 24, 2023

(54) SYSTEMS AND METHODS FOR RECONSTRUCTING DOCUMENTS

(71) Applicant: Steven Thrasher, Dallas, TX (US)

(72) Inventor: Steven Thrasher, Dallas, TX (US)

(21) Appl. No.: 18/094,980

(22) Filed: Jan. 9, 2023

Related U.S. Application Data
(60) Provisional application No. 63/297,672, filed on Jan. 7, 2022.

(51) Int. Cl. G06T 5/50; G06T 5/00; G06V 10/44; G06V 10/774; G06V 10/70

(52) U.S. Cl. CPC G06T 5/50; G06T 5/001; G06V 10/44; G06V 10/774; G06V 10/768; G06T 2207/20081; G06T 2207/30176

(57) ABSTRACT

The present invention relates to system and methods of reconstructing ancient documents. The method includes receiving a service request, from a requesting application, for reconstruction of an ancient document from a plurality of image captures and determining a plurality of image contexts from each of the plurality of image captures. Further, the method includes reconstructing the ancient document by associating at least one determined image context with each of the plurality of image captures and providing a reconstructed ancient document to the requesting application. The present invention provides systems and methods for reconstructing documents that largely restores the words/scripts written in the ancient documents or on other sources having ancient information, thereby restoring the nuances in meaning and local lore in an effective manner.

This Non-Provisional Patent application claims priority from U.S. Provisional Patent Application No. 63/297,672 filed on Jan. 7, 2022 entitled SYSTEMS AND METHODS FOR RECONSTRUCTING DOCUMENTS, to common inventor Thrasher.

### TECHNICAL FIELD

The present invention generally relates to using software to virtually reassemble items that are broken.

### PROBLEM STATEMENT AND HISTORY INTERPRETATION CONSIDERATIONS

This section describes technical field in detail and discusses problems encountered in the technical field. Therefore, statements in the section are not to be construed as prior art.

### Discussion of History of the Problem

Ancient documents and artifacts open windows to the past. Whether as glyphs on papyrus and skins, fragments of plaster or cloth on mummified human remains, cuneiform on clay tablets, chisels on stone monuments and temples, pressings and etchings on metal, or as hundreds of other scripts left on every material accessible to ancient mankind, so much can be learned.

Legendary narratives, business transactions, administrative records, kingly proclamations and much more offer insights into events and beliefs of the past, as well as of the ancient cultures that created them.

Unfortunately, most of these ancient records exist as mere fragmentary pieces such as shreds, pylon blocks, chads, chards—little or none of which can be re-constituted by hand-and-eye.

Past attempts at re-assembling ancient documents have been somewhat fruitful. For example, the Turin Canon (or Turin Kings List), illustrated in FIG. 1 (Prior Art), that provides insights into the successions of ancient pharaohs (at least in so far as it was understood by the 19^{th} Dynasty of Egypt). Yet even the efforts to reconstruct the Turin Canon has been wrought with controversy. For example, the Turin Canon itself has already been re-assembled and then later re-formed (and by necessity re-interpreted) on no fewer than three occasions, leading to ambiguity and confusion when matching the ‘presumed’ written record to the archaeological evidence. Indeed today, the present form of the Turin Canon is under increasing attack as the archaeological records appear to contradict its apparent succession list—as presently constructed.

Another example of an ancient document that is missing substantial portions of its text is the Epic of Gilgamesh (see FIG. 2, which illustrates a portion of the Epic of Gilgamesh). Written on multiple tablets, no comprehensive text exists, and the tablet portions that are accessible present varying stories. As a result, while we can tell that the Epic of Gilgamesh at times evolved, without the full text of each version, the nuances in meaning and local lore are largely lost.

Yet, many thousands of tablet pieces remain to be examined in the British Museum alone. Who knows what cultural riches lie buried in these mounds of mere ‘chips’?

Similar problems confront the Amarna Letters, the Enuma Elis, Egyptian Pylons, and a variety of historically important documents.

It is as if a choir of ten million voices from ancient Mesopotamia, Babylon, Akkad, Sumer, Egypt, the Levant, and thousands of other locations spanning the globe are crying out to be heard. Accordingly, the present invention restores their voice by restoring their writings, inscriptions, and monuments.

### SUMMARY

The above objective is solved by systems and methods of reconstructing ancient documents comprising the features of independent claims. Advantageous embodiments and applications of the present invention are defined in the dependent claims.

One exemplary system comprises a document reconstruction controller, a plurality of chads placed on a surface and at least one imaging unit to capture a plurality of images of the plurality of chads. The plurality of images corresponds to a plurality of image captures.

Initially, a plurality of image contexts is determined from each of the plurality of image captures by determining that a light source applied on each of the plurality of image captures meets a light threshold and in response to determining that the light source applied on each of the plurality of image captures meets the light threshold, the at least one imaging unit captures the plurality of image captures. The plurality of image contexts comprises image data associated with boundary edge, texture and transparency of each of the plurality of image captures.

Further, the document reconstruction controller causes the reconstructed ancient documents to be provided as a service by causing reception of a service request, from a requesting application, for reconstruction of an ancient document from the plurality of image captures. The document reconstruction controller determines the plurality of image contexts from each of the plurality of image captures and reconstructs the ancient document by associating at least one determined image context with each of the plurality of image captures, which is further provided to the requesting application.

The system is provided with artificial intelligence/machine learning capabilities that is continuously trained and provides outputs based on the training.

Of course, the present is simply a Summary, and not a complete description of the invention, which is limited solely by the appended Claims.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 is a prior art depicting the Turin Canon (or Turin Kings List).

FIG. 2 is a prior art depicting a portion of the Epic of Gilgamesh.

FIG. 3 illustrates a system for reconstructing documents.

FIG. 4 is a flow diagram illustrating a method for reconstructing documents.

FIG. 5 is a flow diagram illustrating a training method/technique.

FIG. 6 is a flow diagram illustrating a chad capture render method/technique.

FIG. 7 is a flow diagram illustrating a pre-assembly intelligence method/technique.

FIG. 8 is a flow diagram illustrating a chad assembly method/technique.

FIG. 9 is a flow diagram illustrating a document rendering method/technique.

### DESCRIPTION OF AN EXEMPLARY PREFERRED EMBODIMENT INTERPRETATION CONSIDERATIONS

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words invoke and their equivalents, such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTION OF THE DRAWINGS, A PREFERRED EMBODIMENT

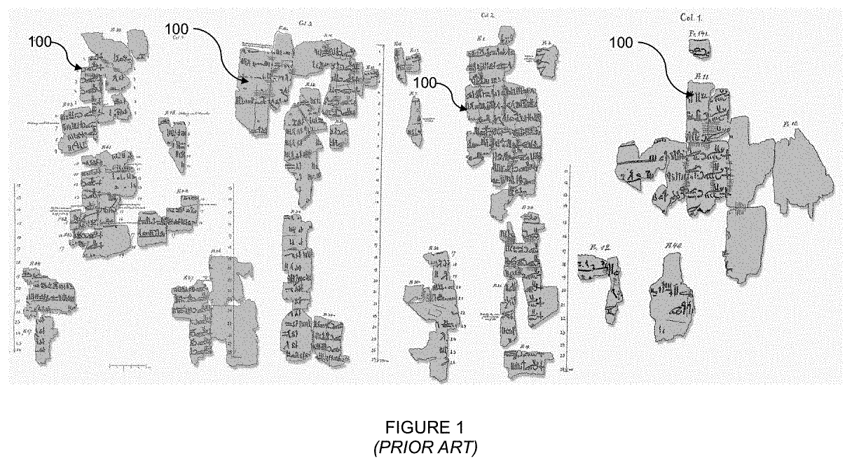

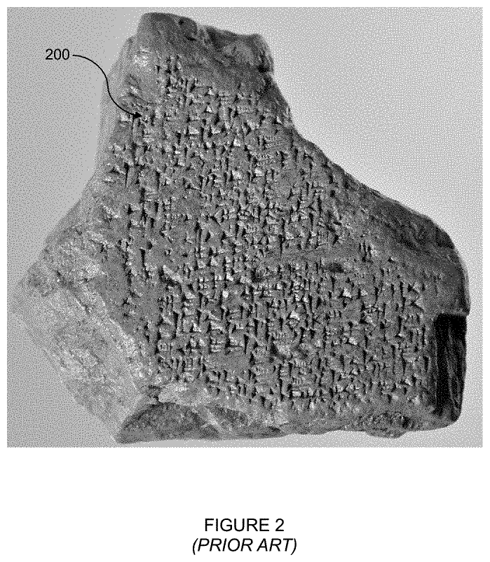

Attempts have been made for re-building ancient documents or other sources having information. For example, the Turin Canon (or Turin Kings List) 100 illustrated in FIG. 1 (Prior Art) that provides insights into the successions of ancient pharaohs. Similarly, the Epic of Gilgamesh 200 illustrated in FIG. 2 (Prior Art) that is an epic poem from ancient Mesopotamia. As the ancient documents or other sources having ancient information such as glyphs on papyrus, a pylon, or skin, or cuneiform on clay tablets, chisels on stone monuments and temples, pressings and etchings on metal, for example, are formed and re-formed (and by necessity re-interpreted) several times, thereby leading to ambiguity and confusion when matching the ‘presumed’ written record to the archaeological evidence. Also, due to the unavailability of full text of such ancient documents or other sources having ancient information, the nuances in meaning and local lore are largely lost.

Although directed to ancient documents, the methods herein broadly define a document to include a medium having a human-created (including printed) message or image thereon, where the medium may scale from writing on a grain of rice to a monumental pylon in ancient Egypt.

Advantageously, the present invention provides systems and methods for reconstructing documents that largely restores the words/scripts written in the ancient documents or on other sources having ancient information, thereby restoring the nuances in meaning and local lore in an effective manner.

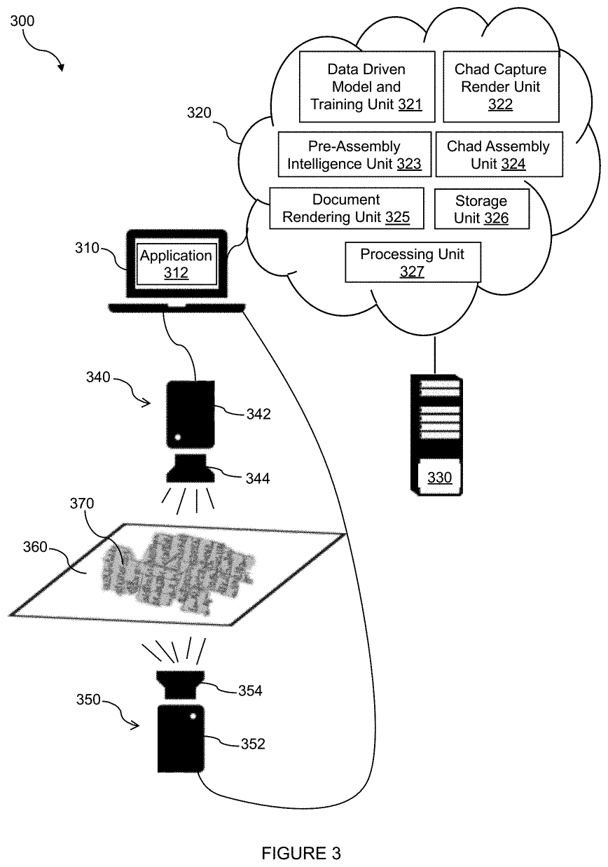

Accordingly, FIG. 3 illustrates a system 300 for reconstructing documents, thus called as a document reconstruction system 300. The document reconstruction system 300 generally comprises a user terminal 310, a cloud-based document reconstruction controller 320, one or more servers 330, a first imaging unit 340, a second imaging unit 350, a surface 360 and a plurality of chads 370. The document reconstruction system 300 may also comprise subsystems, hardware, distributed computing, software, entity interfaces, and user interfaces which enable and deliver the services/functions of the present invention as described herein.

In one embodiment, the user terminal 310, the cloud-based document reconstruction controller 320, the one or more servers 330, the first imaging unit 340, and the second imaging unit 350 are connected with each other via a wired communication medium or a wireless communication medium such as WI-FI, Bluetooth, near field communication, universal serial bus, for example.

The user terminal 310 can be a laptop, a notebook, a desktop computer, a vehicle to everything (V2X) device, a smartphone, a tablet, an internet of things (IoT) device, a television with communication facility, an immersive device, a virtual reality device, a pager or any other computing device including similar hardened and field-specific devices, for example. The user terminal 310 is typically a portable electronic device that can communicate with the one or more servers 330 through a communications network (not shown).

The user terminal 310 hosts an application 312 (aka “requesting application”) that can be accessed by a user via a user interface of the user terminal 310. The requesting application 312 can be, for example, but not limited to an ancient document handling and reconstruction application, a data mining-based research application or the like. The application 312 is configured to receive a service request(s) from the user and to share/forward the service request(s) to the cloud-based document reconstruction controller 320 (aka “document reconstruction controller”). The service request indicates a reconstruction of an ancient document from a plurality of image captures captured from, in one embodiment, a plurality of chads 370. Although, the document reconstruction controller 320 is shown as cloud-based, however, the document reconstruction controller 320 may be locally integrated in the user terminal 310.

Based on the service request, the document reconstruction controller 320 determines a plurality of image contexts from each of the plurality of image captures. The plurality of image contexts includes image data associated with boundary edge, texture and transparency, for example, of each of the plurality of image captures. The boundary edge can be defined as a set of connected pixels that forms a boundary between two disjoint regions. The boundary edge can be, for example, but not limited to a horizontal edge, a vertical edge, and a diagonal edge. The boundary edge is determined by identifying a direction of change in color and texture at each image/text location at a given scale in the plurality of image captures. The texture can be determined as a function of spatial variation of a brightness intensity of pixels in the plurality of image captures.

The document reconstruction controller 320 determines the plurality of image contexts from each of the plurality of image captures using various units such as a data driven model and training unit 321, a chad capture render unit 322, a pre-assembly intelligence unit 323, a chad assembly unit 324, a document rendering unit 325, a storage unit 326 and a processing unit 327, for example, to reconstruct the ancient document by associating at least one determined image context with each of the plurality of image captures and provide a reconstructed ancient document to the requesting application 312, as explained below in detail.

Based on the service request, the chad capture render unit 322 loads expected script rules. The script rules can be, for example, but not limited to, keep heading of the documents larger, use fade in and fade out at a beginning and end of the script or the like. The chad capture render unit 322 enables/activates the first imaging unit 340 and the second imaging unit 350 to capture the plurality of image captures from the plurality of chads 370. In an embodiment, the activation of the first imaging unit 340 and the second imaging unit 350 can be done manually. While capturing the plurality of image captures, the plurality of chads 370 is placed on the surface 360. The surface 360 can be, for example, but not limited to, a glass surface and a transparent table surface. In order to detect a best surface image for reconstructing the documents, the surface 360 can be a solid table or a back of the glass covered by a dark (preferably black) surface. The surface 360 allows for back lighting of fragments (i.e., the plurality of chads 370)—so that the document reconstruction system 300 can detect holes, fibers, even plant cells and animal cells and fossils, and use these as guides for re-forming or reconstructing the documents.

The first imaging unit 340 and the second imaging unit 350 may include a first camera 342 and a first light source 344 and a second camera 352 and a second light source 354, respectively. Hereinafter, the first camera 342 and the second camera 352 are combinedly referred to as camera 342, 352 and the first light source 344 and the second light source 354 are combinedly referred to as light sources 344, 354. The camera 342, 352 can be a microscope camera, an edge sensor based camera, for example. In alternative embodiments, the cameras 342, 352 are mobile phone cameras, and need not be co-located in space or time (although it is preferable for the time of a capture of each image to be known). Cameras 342, 352, alternatives and equivalents may capture still images, video, or burst images. The light sources 344, 354 can be an LED (Light Emitting Diode) light source, an ultraviolet (UV) light source, an Infrared (IR) light source, an X-Ray light source, for example. In alternative embodiments a light source may be a natural light source.

The first imaging unit 340 and the second imaging unit 350 provide an ability to view magnified objects under normal external lighting sources such as white light or under near infrared (IR), near fluorescent ultraviolet (UV) lighting by simply switching from one to another. The first imaging unit 340 and the second imaging unit 350 also provide lighting adjustment options including intensity settings as well as have the ability to turn on or off the light source 344 and 354 based on requirements. Further, the first imaging unit 340 and the second imaging unit 350 are configured to provide various magnification features. The first imaging unit 340 and the second imaging unit 350 have an option of switching between one light source to another light source. In an example, the first imaging unit 340 and the second imaging unit 350 can switch between a white LED light and a fluorescent ultra violet light. The first imaging unit 340 and the second imaging unit 350 allow a user to “capture” either a photograph, video, or time-lapsed video.

The chad capture render unit 322 enables the light source 344, 354 to be applied on each of the plurality of chads 370 placed on the surface 360 and determines whether the light source applied on each of the plurality of chads 370 meets a light threshold. If the light threshold matches, the chad capture render unit 322 receives/captures one or more images of each of the plurality of chads 370 using the cameras 342, 352. If the light threshold does not match, the chad capture render unit 322 automatically adjusts the light source 344, 354 and then capture the one or more images of each of the plurality of chads 370 using the cameras 342, 352.

The chad capture render unit 322 is further configured to determine the plurality of image contexts from each of the plurality of captured image captures. That is, the chad capture render unit 322 detects one or more texture data, one or more transparency data, boundary edges and likely script portions associated with the plurality of chads 370 which can be stored in the storage unit 326. The one or more texture data may be an image that represents one or more parts of a feature of the document. The one or more texture data may be represented in two-dimension and three-dimension. The one or more texture data include gradients, vectors, and hashes, for example. The one or more texture data may also be represented as an order of letter writing, a letter spacing, grey-levels of voxels, a position of pixels forming a trace in the texture data, a width of a trace in the texture data, or gradient-based features, slope-based features, features based on internal and external contours, topographic features based on texture analysis. The one or more transparency data includes plant fibres, animal skin or hair patterns and attributes, plant pectin, holes and nicks, and hidden features, for example. The likely script portions include impressions, inks and equivalents, extra marks, signature marks and as well as script and hand writing nuances, for example.

Further, the pre-assembly intelligence unit 323 is configured to suggest/recommend a script type. The script type can be assigned with a script ID. The script type can be, for example, but not limited to, a best fit script, a broad script, a personal script (e.g., customizable/customized script), a language based script or the like. The pre-assembly intelligence unit 323 is also configured to load an alternative script and to override any previous script. Further, the pre-assembly intelligence unit 323 loads and tests a three dimensional (3D) form factor. The 3D form factor can be, for example, but not limited to scroll, book, folded, arc, and stella to burn holes and edges, ink bleeds, poke holes, and insect/animal chewing, for example. The pre-assembly intelligence unit 323 also suggests the 3D form factor that can be chosen or replaced with another 3D form factor.

The chad assembly unit 324 is configured to apply image data to the plurality of image contexts such as texture, transparency, boundaries, script elements and other detected characteristics and render best fit (RBF) the same as a function (texture), a function (transparency), a function (boundaries), a function (script elements), and a function (other detected characteristics), for example.

Once the chad assembly unit 324 has performed the aforesaid functions, the document rendering unit 325 assigns document boundary(ies) fit(s), transparency fit(s), texture fit(s), edge fit(s), script fit(s) and renders the same. The assignment of the document boundary(ies) fit(s), the transparency fit(s), the texture fit(s), the edge fit(s), the script fit(s) may be based on probabilities. The rendering of the document boundary(ies) fit(s), the transparency fit(s), the texture fit(s), the edge fit(s), the script fit(s) may be based on probabilities or may be rank based. The document rendering unit 325 may use pairwise patch information to assign labels to edges representing a spatial relationships among the edges. The document rendering unit 325 classifies the relationship among the edges as Up-side edges, Down-side edges, Left side edges, Right side edges or None. The assignment and rendering processes assist in building best document fits i.e., help in determining at least one image context that can be associated with each of the plurality of image captures. The document rendering unit 325 determines and displays best document fit option(s) (i.e., the at least one determined image context) and receives the user's selection(s) of document and portions. Based on the user's selection(s), the document rendering unit 325 associates the at least one determined image context with each of the plurality of image captures and displays a primary document, which may be the reconstructed ancient document.

In an embodiment of the present invention, the reconstructed ancient document is provided with one or more options. The option(s) can be, for example, but not limited to a category of the reconstructed ancient document, a level of accuracy of the reconstructed ancient document and an index of the reconstructed ancient document. The category of the reconstructed ancient document can be, for example, medical document, a war zone related document, navigation related documents or the like. The level of estimated accuracy can vary from 0% to 100%, allowing for Bayesian analysis.

In an alternate embodiment, the document reconstruction controller 320 is configured to reconstruct the ancient document by utilizing streams of elements associated with each of the plurality of image captures using the processing unit 327. The processing unit 327 retrieves the streams of elements associated with each of the plurality of image captures from the storage unit 326 or from the one or more servers 330. The streams of elements correspond to grammatical or textual elements that could assist in forming a concept and recreating the ancient documents based on that concept. For example, guessing or identifying prepositions, gerunds or other textual elements related to a specific ancient story/incident. The processing unit 327 identifies one or more vector paths associated with the respective streams of elements. The one or more vector paths are indicative of one or more possible reconstruction features in the storage unit 326 corresponding to the respective streams of elements. The one or more possible reconstruction features for each of the plurality of image captures comprise the likely boundary of the images, transparency of the images, texture of the images and scripts of the images that are used in reconstructing the ancient document. The processing unit 327 is configured to associate the at least one determined image context with the determined at least one possible reconstruction features. Further, the processing unit 327 analyzes the one or more possible reconstruction features in conjunction with a respective conceptual determinative and provides the reconstructed ancient document based on the analysis of the one or more possible reconstruction features. The processing unit 327 can discard any possible reconstruction features determined not to correspond with the conceptual determinative.

Additionally, the processing unit 327 may include one or more processors, which may be configured to perform all the processing functionalities of the present invention. The one or more processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. At least one of aforesaid units may perform their functions by using the driven model and training unit 321. A function associated with the data driven model and training unit 321 may be performed by utilizing the information stored in the storage unit 326 like a non-volatile memory, volatile memory, for example and by utilizing the processing unit 327.

The data driven model and training unit 321 is an artificial intelligence platform which is created from a machine learning method called deep learning. The machine learning method enables the platform to automatically learn and improve from experience, over a period of time, without being explicitly programmed.

The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification of the image. Similarly, in the present invention, a training data set is developed from labeled images of chads, for example to enhance the learning capability of the data driven model and training unit 321.

Alternatively, any machine learning paradigm instead of neural networks can be used in the training and learning process.

The data driven model and training unit 321 is configured to continuously obtain a training data comprising the plurality of image contexts from each of the plurality of image captures. The data driven model and training unit 321 is trained by loading known portions of the plurality of chads 370, script images and rules and by analyzing the training data to find the one or more possible reconstruction features for the plurality of image captures. Cross-training of the data driven model and training unit 321 may also be performed using the one or more possible reconstruction features for the plurality of image captures that generates the one or more possible reconstruction features, where each possible reconstruction feature to be used to reconstruct the ancient document.

The data driven model and training unit 321 receives a feedback corresponding to the one or more possible reconstruction features to reconstruct the ancient document over a period of time and updates the one or more generated possible reconstruction features to reconstruct the ancient document based on the received feedback. That is, the data driven model and training unit 321 confirms and corrects the fits over a period of time.

Additionally, the one or more servers 330 store all the information being utilized in the present invention. The document reconstruction controller 320 can fetch the information from the one or more servers 330 whenever required. The one or more servers 330 may be a remote server, a virtual server, and an edge server, for example. In an embodiment, the one or more servers 330 may act as the document reconstruction controller 320.

Although FIG. 3 shows various components of the document reconstruction system 300 but it is to be understood that other embodiments are not limited thereon. The document reconstruction system 300 may include less or more number of components. Further, the labels or names of the components are used only for illustrative purpose and does not limit the scope of the present invention. One or more components can be combined together to perform same or substantially similar function in the document reconstruction system 300.

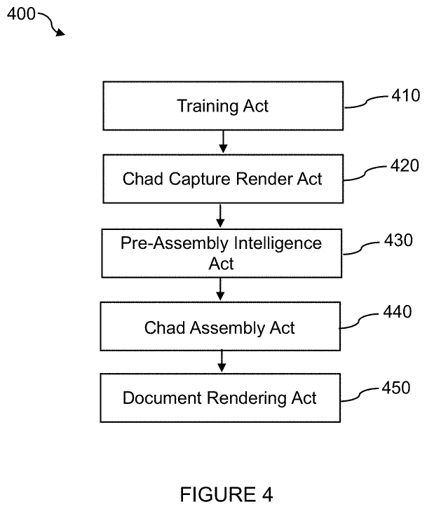

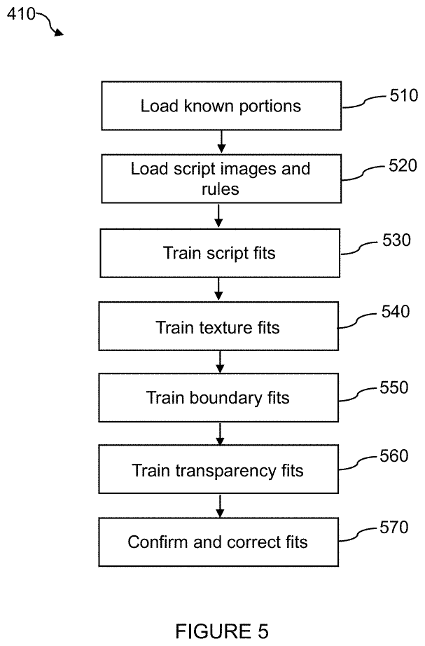

FIG. 4 is a flow diagram 400 illustrating a method for reconstructing documents (aka “document reconstruction method”). The document reconstruction method begins in a training act 410 which is explained in conjunction with FIG. 5. Referring to FIG. 5, in the training act 410, the data driven model and training unit 321 is loaded with known portion of the plurality of chads 370 at act 510 and loaded with script images and rules at act 520. At act 530, act 540, act 550 and act 560, the data driven model and training unit 321 is trained for script fits, texture fits, boundary fits and transparency fits respectively. The data driven model and training unit 321 is configured to confirm and correct the aforesaid fits over a period of time at act 570.

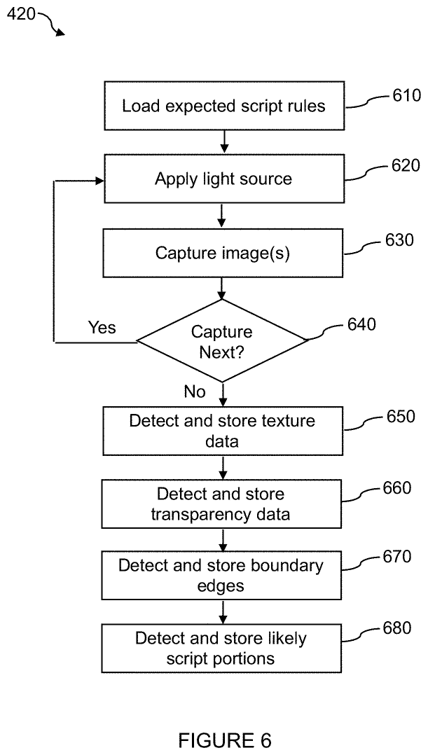

Following the training act 410, a chad capture render act 420 begins, which is explained in conjunction with FIG. 6. Referring to FIG. 6, the chad capture render act 420 includes loading expected script rules at act 610 and applying the light source at act 620 followed by capturing the one or more images of each of the plurality of chads 370 by meeting the light threshold at act 630. The light threshold may be a user defined threshold that may be modified depending upon the requirement. At act 640, the chad capture render unit 322 determines whether to capture next image or not. If the user indicates that he wishes to capture further image(s) as indicated by “Yes” path, then the chad capture render act 420 returns to the apply light source act (act 620). If, on the other hand, the user indicates that he does not wish to capture further image(s), then the chad capture render act 420 proceeds to detection and storage acts, where the chad capture render act 420 detects and stores the texture data at act 650, detects and stores the transparency data at act 660, detects and stores the boundary edges at act 670 and detects and stores likely script portions at act 680.

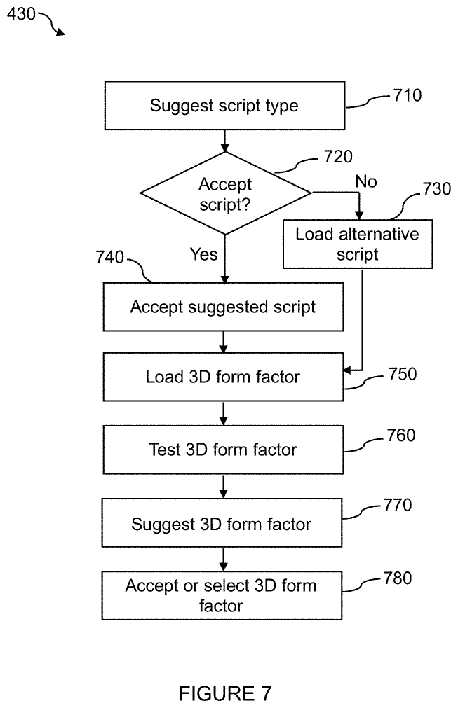

Next, the document reconstruction method includes a pre-assembly intelligence act 430. The pre-assembly intelligence act 430 is explained in conjunction with FIG. 7. Referring to FIG. 7, the pre-assembly intelligence unit 323 suggests the script type at act 710. The pre-assembly intelligence act 430 determines whether to accept the script or load another/alternative script at act 720. If the user indicates that he wishes to accept the suggested script type as indicated by “Yes” path, then the pre-assembly intelligence act 430 proceeds to accept suggested script act (act 740), else the pre-assembly intelligence act 430 proceeds to load alternative script act (act 730) as indicated by “No” path. Following the accept suggested script act 740 or the load alternative script act 730, the pre-assembly intelligence act 430 loads the 3D form factor at act 750, tests the 3D form factor at act 760, suggests the 3D form factor at act 770 and accepts or selects the 3D form factor at act 780.

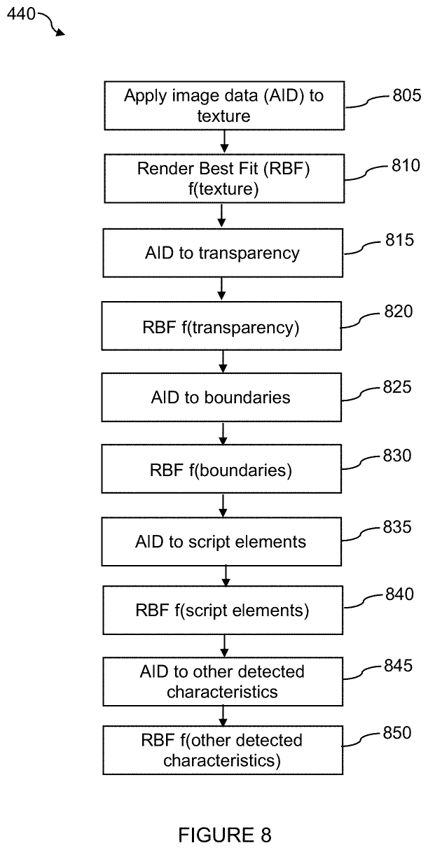

Following the pre-assembly intelligence act 430, a chad assembly act 440 begins. The chad assembly act 440 is explained in conjunction with FIG. 8. Referring to FIG. 8, the chad assembly act 440 applies the image data to the plurality of image contexts and renders best fit(s) for the same. Particularly, at act 805, at act 815, at act 825, at act 835 and at act 845, the chad assembly act 440 applies image data to the texture, transparency, boundaries, script elements and other detected characteristics respectively. Next, at act 810, at act 820, at act 830, at act 840 and act 850, the chad assembly act 440 renders best fits as a function such as f(texture), f(transparency), f(boundaries), f(script elements), f(other detected characteristics) respectively.

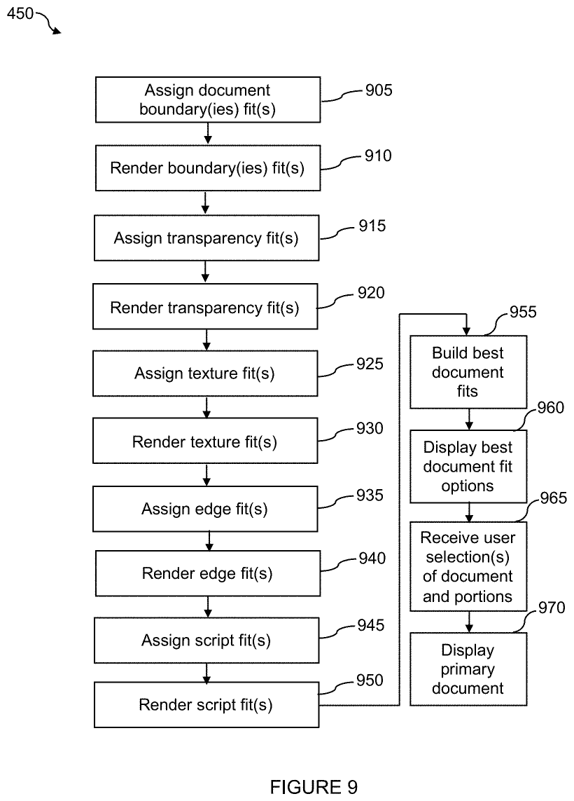

Following the chad assembly act 440, a document rendering act 450 begins, which is explained in conjunction with FIG. 9. Referring to FIG. 9, the document rendering act 450 associates the at least one determined image context with each of the plurality of image captures to display the primary document. Particularly, the document rendering act 450 assigns the document boundary(ies) fit(s), the transparency fit(s), the texture fit(s), the edge fit(s) and the script fit(s) at acts 905, 915, 925, 935, 945 respectively and renders the transparency fit(s), the texture fit(s), the edge fit(s) and the script fit(s) at acts 910, 920, 930, 940, 950 respectively. Post assignment and rendering, the document rendering act 450 builds best document fits at act 955 and displays the best document fit options at act 960. At act 965, the user can select the best fits of document and portions, which generates and displays the primary document at act 970.

It may be noted that FIGS. 4 through 9 are to be understood in conjunction with FIG. 3.

The various actions, acts, blocks, acts, or the like in the flow diagrams may be performed in the order presented, in a different order or simultaneously. Further, in some embodiments, some of the actions, acts, blocks, acts, or the like may be omitted, added, modified, skipped, or the like without departing from the scope of the present invention.

The present invention may be used in various applications such as forensics, biomedical or machine vision applications, for example.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

I claim:

1. A method for reconstructing a document, the method comprising:
receiving a service request from a requesting application for reconstruction of a document from a plurality of images;
determining by a document reconstruction controller a plurality of image contexts from each of the plurality of images;
reconstructing by the document reconstruction controller the document by associating at least one determined image context with each of the plurality of images; and
providing by the document reconstruction controller a reconstructed document to the requesting application.

2. The method of claim 1 wherein the plurality of image contexts comprises image data associated with one or more of the following: a boundary edge, a texture, or a transparency.

3. The method of claim 1 wherein determining the plurality of image contexts from each of the plurality of images comprises:
determining that a light source applied on each of the plurality of images meets a light threshold;
capturing each of the plurality of images in response to determining that the light source applied on each of the plurality of images meets the light threshold; and
determining the plurality of image contexts from each of the plurality of captured images.

4. The method of claim 1 wherein associating the at least one determined image context with each of the plurality of images comprising:
retrieving streams of elements associated with each of the plurality of images from a storage unit;
identifying one or more vector paths associated with the respective streams of elements, wherein the one or more vector paths are indicative of one or more possible reconstruction features in the storage unit corresponding to the respective streams of elements and wherein the one or more possible reconstruction features are used in reconstructing the document; and
associating at least one determined image context with the determined at least one possible reconstruction features.

5. The method of claim 4 further comprising:
analyzing the one or more possible reconstruction features in conjunction with a respective conceptual determinative;
providing the reconstructed document based on the analysis of the one or more possible reconstruction features; and
discarding any possible reconstruction features determined not to correspond with the conceptual determinative.

6. The method of claim 4 wherein the one or more possible reconstruction features for each of the plurality of images comprise boundary of the images, transparency of the images, texture of the images and scripts of the images.

7. The method of claim 1 wherein the at least one determined image context associated with each of the plurality of images is determined using a data driven model and training unit, wherein the data driven model and training unit is trained by:
obtaining continuous training data comprising the plurality of image contexts from each of the plurality of images;
training of the data driven model and training unit by analyzing the training data to find one or more possible reconstruction features for the plurality of images;
cross-training of the trained data driven model and training unit using the one or more possible reconstruction features for the plurality of images; and
generation of the one or more possible reconstruction features using the cross-trained data driven model and training unit, each possible reconstruction feature to be used to reconstruct the document.

8. The method of claim 7 further comprising:
receiving a feedback corresponding to the one or more possible reconstruction features to reconstruct the document over a period of time; and
updating the one or more generated possible reconstruction features to reconstruct the document based on the received feedback.

9. The method of claim 1 wherein the reconstructed document is provided with at least one option, wherein the at least one option is selected from at least one of: a category of the reconstructed document, a level of accuracy of the reconstructed document and an index of the reconstructed document.

10. A system for reconstructing documents, the system comprising a document reconstruction controller configured to cause the reconstructed documents to be provided as a service by causing:
reception of a service request, from a requesting application, for reconstruction of a document from a plurality of images;
determination of a plurality of image contexts from each of the plurality of images;
reconstruction of the document by associating at least one determined image context with each of the plurality of images; and
provide a reconstructed document to the requesting application.

11. The system of claim 10 wherein the plurality of image contexts comprises image data associated with boundary edge, texture and transparency of each of the plurality of images.

12. The system of claim 10 wherein determination of the plurality of image contexts from each of the plurality of images comprises:
determining whether a light source applied on each of the plurality of images meets a light threshold;
capturing each of the plurality of images in response to determining that the light source applied on each of the plurality of images meets the light threshold; and
determining the plurality of image contexts from each of the plurality of captured images.

13. The system of claim 10 wherein associating the at least one determined image context with each of the plurality of images comprising:
retrieving streams of elements associated with each of the plurality of images from a storage unit;
identifying one or more vector paths associated with the respective streams of elements, wherein the one or more vector paths are indicative of one or more possible reconstruction features in the storage unit corresponding to the respective streams of elements and wherein the one or more possible reconstruction features are used in reconstructing the document; and
associating at least one determined image context with the determined at least one possible reconstruction features.

14. The system of claim 13 further comprising:
analyzing the one or more possible reconstruction features in conjunction with a respective conceptual determinative;
providing the reconstructed document based on the analysis of the one or more possible reconstruction features; and
discarding any possible reconstruction features determined not to correspond with the conceptual determinative.

15. The system of claim 13 wherein the one or more possible reconstruction features for each of the plurality of images comprises boundary of the images, transparency of the images, texture of the images and scripts of the images.

16. The system of claim 10 wherein the at least one determined image context associated with each of the plurality of images is determined using a data driven model and training unit, wherein the data driven model and training unit is trained by:
obtaining continuous training data comprising the plurality of image contexts from each of the plurality of images;
training of the data driven model and training unit by analyzing the training data to find one or more possible reconstruction features for the plurality of images;
cross-training of the trained data driven model and training unit using the one or more possible reconstruction features for the plurality of images; and
generation of the one or more possible reconstruction features using the cross-trained data driven model and training unit, each possible reconstruction feature to be used to reconstruct the document.

17. The system of claim 16 further comprising:
receiving a feedback corresponding to the one or more possible reconstruction features to reconstruct the document over a period of time; and
updating the one or more generated possible reconstruction features to reconstruct the document based on the received feedback.

18. The system of claim 10 wherein the reconstructed document is provided with at least one option, wherein the at least one option includes a category of the reconstructed document, a level of accuracy of the reconstructed document and an index of the reconstructed document.

19. The system of claim 10 further comprising:
a plurality of chads placed on a surface and at least one imaging unit to capture a plurality of images of the plurality of chads, wherein the plurality of images corresponds to the plurality of images.
